(19) United States
(12) Patent Application Publication
(10) Pub. No.: US 2026/0184640 A1
(43) Pub. Date: Jul. 2, 2026

(54) CERAMIC MATERIAL AND MANUFACTURING METHOD THEREOF

(71) Applicant: INDUSTRIAL TECHNOLOGY RESEARCH INSTITUTE, Hsinchu (TW)

(72) Inventors: Tien-Heng HUANG, Chiayi County (TW); Kuo-Chuang CHIU, Hsinchu City (TW); Li-Ching CHO, Hsinchu County (TW); Jih-Hsiang YEH, Hsinchu (TW); Yan-Ren CHEN, Yilan County (TW)

(73) Assignee: INDUSTRIAL TECHNOLOGY RESEARCH INSTITUTE, Hsinchu (TW)

(21) Appl. No.: 19/003,491

(22) Filed: Dec. 27, 2024

(51) Int. Cl. C04B 35/04; C04B 35/64

(52) U.S. Cl. CPC C04B 35/04; C04B 35/64; C04B 2235/3206; C04B 2235/3267; C04B 2235/3277; C04B 2235/61

(57) ABSTRACT

A ceramic material, includes: a magnesium oxide and a doped oxide, wherein the doped oxide includes cobalt tetroxide, europium trioxide or manganese dioxide, and wherein a weight ratio of magnesium oxide to the doped oxide is 97:1 to 85:12. In addition, the disclosure also provides a method for manufacturing a ceramic material, including: mixing a magnesium oxide powder and a doped oxide powder, and sintering the mixed magnesium oxide powder and the doped oxide powder at a temperature of 1300° C. to 1650° C. to obtain the ceramic material, wherein the doped oxide powder includes a cobalt tetroxide powder, a europium trioxide powder or a manganese dioxide powder, and wherein a weight ratio of the magnesium oxide powder to the doped oxide powder is 99.9:0.1 to 92:8.

### TECHNICAL FIELD

The technical field relates to a ceramic material and a manufacturing method thereof, and in particular it relates to a ceramic material containing a magnesium oxide and a doped oxide, a manufacturing method thereof.

### BACKGROUND

Advancements in high-temperature industrial technologies have led to an increasing demand for refractory materials that offer both high-temperature stability and strong chemical resistance. Commonly used refractory materials include magnesium oxide, aluminum oxide, quartz, silicon carbide, boron nitride, and zirconia oxide. However, in microwave heating, a widely used high-temperature industrial method, certain refractory materials absorb microwaves, which may reduce the efficiency of microwave energy transfer to the heated object.

For instance, the process of graphitizing carbon fibers requires an environment with extremely high temperatures, typically between 1800° C. and 2000° C., and often relies on microwave heating. Some refractory materials tend to absorb microwaves, which can lower the efficiency of energy transfer to the raw materials in carbon fiber production. Additionally, certain refractories may experience a loss of mechanical properties or undergo redox reactions under such high temperatures, causing the release of volatile components that contaminate the raw materials. This contamination can negatively impact the purity and properties of the carbon fibers produced. As a result, a major focus in advancing high-temperature industrial processes is the development of refractory materials that allow microwave penetration, have high hardness, withstand extreme heat, and maintain chemical stability.

### SUMMARY

An embodiment of the disclosure provides a ceramic material, including: a magnesium oxide (MgO) and a doped oxide, wherein the doped oxide comprises cobalt tetroxide (Co₃O₄), europium trioxide (Eu₂O₃) or manganese dioxide (MnO₂); and wherein a weight ratio of magnesium oxide to the doped oxide is 97:1 to 85:12.

Another embodiment of the disclosure provides a method for manufacturing the ceramic material, including: mixing a magnesium oxide powder and a doped oxide powder; and sintering the mixed magnesium oxide powder and the doped oxide powder at a temperature of 1300° C. to 1650° C. to obtain the ceramic material, wherein the doped oxide powder includes a cobalt tetroxide powder, a europium trioxide powder or a manganese dioxide powder; and wherein a weight ratio of the magnesium oxide powder to the doped oxide powder is 99.9:0.1 to 92:8.

### BRIEF DESCRIPTION OF THE DRAWINGS

FIG. 1(a) to FIG. 1(b) show the relationship between the hardness of ceramic material and the composition of a magnesium oxide powder and a doped oxide powder at various weight ratios. In FIG. 1(a), the doped oxide powder is Co₃O₄, Eu₂O₃ or MnO₂, while in FIG. 1(b), the doped oxide powder is lanthanum oxide (La₂O₃), molybdenum dioxide (MoO₂), nickel oxide (NiO) or zinc oxide (ZnO).

FIG. 2 shows the relationship between the dielectric constant (Dk) of the ceramic material and the composition of a magnesium oxide powder and a doped oxide powder (Co₃O₄, Eu₂O₃ or MnO₂) at various weight ratios.

FIG. 3 shows the relationship between the dissipation factor (Df) of the ceramic material and the composition of a magnesium oxide powder and a doped oxide powder (Co₃O₄, Eu₂O₃ or MnO₂) at various weight ratios.

FIG. 4(a) to FIG. 4(f) show the SEM images of the ceramic materials made from the magnesium oxide powder and the doped oxide powder (Co₃O₄) at various weight ratio, in which FIG. 4(a) to FIG. 4(f) are SEM images of the ceramic materials made from the magnesium oxide powder and Co₃O₄ powder with a weight ratio of 100:0, 99:1, 98.5:1.5, 98:2, 96:4 and 92:8, respectively.

FIG. 5 shows the SEM image of the ceramic material made from the magnesium oxide powder and Co₃O₄ powder at a weight ratio of 98:2.

FIG. 6 shows the XRD image of the ceramic material made from the magnesium oxide powder and Co₃O₄ powder at a weight ratio of 98:2.

FIG. 7 shows the SEM image of the ceramic material made from the magnesium oxide powder and ZnO powder at a weight ratio of 98:2.

FIG. 8(a) to FIG. 8(c) show the SEM images and the EDS image of a graphitized fiber made by the ceramic materials according to an embodiment of the disclosure, in which FIG. 8(a) and FIG. 8(b) are the SEM images of the graphitized fiber, while FIG. 8(c) is the EDS image of the square area in FIG. 8(b).

### DETAILED DESCRIPTION

The following description of the ceramic material according to the disclosure and the manufacturing method thereof is provided in conjunction with the accompanying figures, but is not intended to limit the scope of the disclosure.

An embodiment of the disclosure provides a ceramic material, including: magnesium oxide and a doped oxide, wherein the doped oxide includes cobalt tetroxide (Co₃O₄), europium trioxide (Eu₂O₃) or manganese dioxide (MnO₂); and wherein a weight ratio of magnesium oxide to the doped oxide is 97:1 to 85:12. In an embodiment of the disclosure, the Vickers hardness of the ceramic material is 450 Hv10 to 750 Hv10 and the dissipation factor (Df) of the ceramic material is 0.0001 (1 GHz) to 0.0007 (1 GHz).

In an embodiment of the disclosure, the ceramic material may further include unavoidable impurities. Specifically, the unavoidable impurities may account for 2 to 3 percent of the total weight of the ceramic material. More precisely, with respect to a total weight of 100 parts by weight of the ceramic material, aside from a total of 97 to 98 parts by weight of the magnesium oxide and the doped oxide, the ceramic material also includes 2 to 3 parts by weight of the impurities. These impurities may include Al₂O₃, SiO₂, CaO, Fe₂O₃ or a combination thereof.

In an embodiment of the disclosure, when the doped oxide is cobalt tetroxide, the weight ratio of magnesium oxide to cobalt tetroxide ranges from 86.4:11.13 to 96:1.5. In some embodiments, the Vickers hardness of the ceramic material ranges from 459.8 Hv10 to 700 Hv10 and the dissipation factor (Df) of the ceramic material ranges from 0.0003 (1 GHz) to 0.0007 (1 GHz).

The ceramic material of the disclosure offers outstanding mechanical and dielectric properties due to the inclusion of magnesium oxide and doped oxides. Furthermore, the ceramic tube made from the ceramic material of the disclosure, when used in microwave heating, will not contaminate the heated object. For example, the ceramic tube made from the ceramic material of the disclosure, when used in the microwave heating of graphitized carbon fibers, will not contaminate the carbon fibers.

An embodiment of the disclosure provides a method for the manufacturing ceramic material, including: mixing a magnesium oxide powder and a doped oxide powder; and sintering the mixed magnesium oxide powder and the doped oxide powder at a temperature of 1300° C. to 1650° C. to obtain the ceramic material, wherein the doped oxide powder includes Co₃O₄ powder, Eu₂O₃ powder or MnO₂ powder; and wherein the weight ratio of the magnesium oxide powder to the doped oxide powder is 99.9:0.1 to 92:8. In the method for manufacturing the ceramic material according to an embodiment of the disclosure, the purity of magnesium oxide powder may be greater than or equal to 98%.

The method for manufacturing ceramic material of the disclosure enhances the sinterability of the ceramic material by doping magnesium oxide powder with a specific type and proportion of doped oxide powder. This approach not only improves the sintering process but also increases the hardness of the resulting ceramic material and reduces the dissipation factor.

In an embodiment of the disclosure, when the doped oxide powder is Co₃O₄ powder, the weight ratio of magnesium oxide powder to Co₃O₄ powder can be 99:1 to 92:8.

In an embodiment of the disclosure, when the doped oxide powder is Co₃O₄ powder and the weight ratio of magnesium oxide powder to Co₃O₄ powder is 98.5:1.5 to 98:2, a precipitate is formed at the grain boundaries of the magnesium oxide.

In an embodiment of the disclosure, when the doped oxide powder is Co₃O₄ powder, the weight ratio of magnesium oxide powder to Co₃O₄ powder is 99:1 to 92:8, the Vickers hardness of the ceramic material is 450 Hv10 to 749 Hv10, and the dissipation factor (Df) of the ceramic material is 0.00027 (1 GHz) to 0.0007 (1 GHz).

In an embodiment of the disclosure, when the doped oxide powder is Eu₂O₃ powder, the weight ratio of magnesium oxide powder to Eu₂O₃ powder is 98.5:1.5 to 92:8, the Vickers hardness of the ceramic material is 610 Hv10 to 750 Hv10, and the dissipation factor (Df) of the ceramic material is 0.00012 (1 GHz) to 0.00025 (1 GHz).

In an embodiment of the disclosure, when the doped oxide powder is MnO₂ powder, the weight ratio of magnesium oxide powder to MnO₂ powder is 99.5:0.5 to 95.5:4.5, the Vickers hardness of the ceramic material is 489 Hv10 to 639 Hv10, and the dissipation factor (Df) of the ceramic material is 0.00022 (1 GHz) to 0.00034 (1 GHz).

The following provides a description of the preparation procedure, the testing measurement, and the test results of the ceramic materials for various Examples and Comparative Examples presented in the disclosure.

Preparation of ceramic materials: The magnesium oxide powder and the doped oxide powder are mixed according to compositions and ratios as shown in Table 1 to Table 7, and the mixture is then sintered at 1650° C. to obtain the ceramic materials.

The magnesium oxide powder used in each Example and Comparative Example of the disclosure is a light calcined magnesium oxide with a purity of 98% and a particle size of 6.9 um to 36.3 um. The Co₃O₄ powder used in Example 1 to Example 4 is a Co₃O₄ powder with a purity of 99.5% and a particle size of 4.3 um to 11.73 um. The Eu₂O₃ powder used in Example 5 to Example 6 is a Eu₂O₃ powder with a purity of 99.99% and a particle size of 3.7 um to 11.7 um. The MnO₂ powder used in Example 7 to Example 8 is a MnO₂ powder with a purity of 98% and a particle size of 15.8 um to 52.6 um. The La₂O₃ powder used in Comparative Example 2 to Comparative Example 5 is a La₂O₃ powder with a purity of 99.999% and a particle size of 2.09 um to 6.7 um. The MoO₂ powder used in Comparative Example 6 to Comparative Example 9 is a MoO₂ powder with a purity of 99.99% and a particle size of 7.5 um to 45.2 um. The NiO powder used in Comparative Example 10 to Comparative Example 14 is a NiO powder with a purity of 99.8% and a particle size of 0.67 um to 1.88 um. The ZnO powder used in Comparative Example 15 to Comparative Example 19 is a ZnO powder with a purity of 99% and a particle size of 0.36 um to 4.81 um.

The testing methods for the material properties are as follows:

Hardness measurement is performed using a touch-type Vickers hardness tester (HVS-10F). Pellet samples with a diameter of 12 mm to 13 mm and a thickness of 1.0 mm to 2.5 mm are tested under a 10 kgf load for a duration of 15 seconds.

Dielectric constant (Dk) and dissipation factor (Df) are measured using an HP 4291B RF impedance/material analyzer. Pellet samples with a diameter of 12 mm to 13 mm and a thickness of 1.0 mm to 2.5 mm are tested using a parallel plate method. The test is conducted at a frequency of 1 GHz, with a temperature of 25° C. and a humidity of 65%.

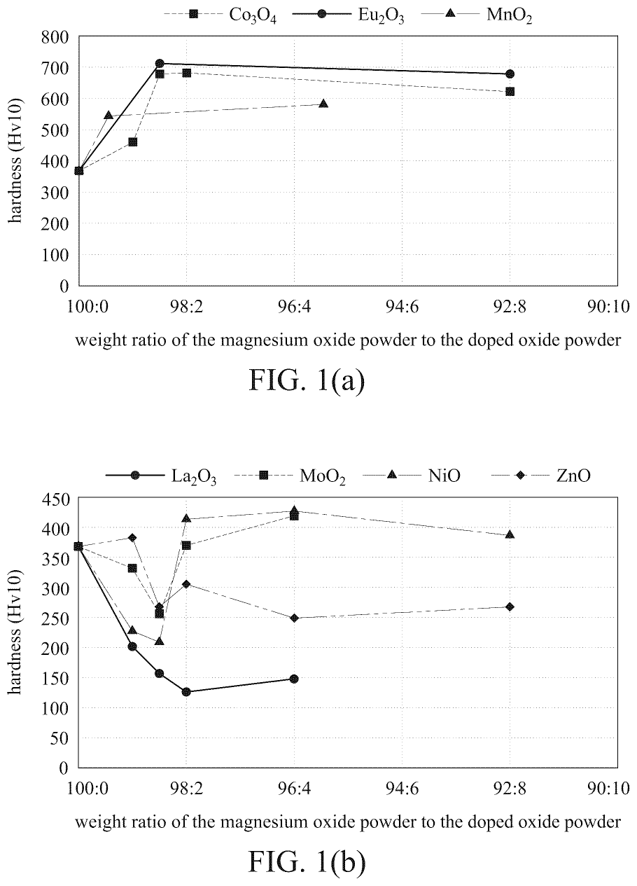

Table 1 to Table 7 and FIG. 1 to FIG. 3 show the raw material compositions and property test results of the ceramic materials of each Examples and Comparative Example.

TABLE 1
The compositions and property test results of
the ceramic materials at various weight ratios of magnesium
oxide powder to Co₃0₄ powder.

| | Weight | | | |
|---|---|---|---|---|
| | ratio of | | | |
| | magnesium | | | |
| | oxide powder | | | |
| | to Co₃O₄ | Hardness | Dk | Df |
| | powder | (Hv10) | (1 GHz) | (1 GHz) |
| Comparative | 100:0 | 368.1 | 7.4929 | 0.000526 |
| Example 1 | | | | |
| Example 1 | 99:1 | 459.8 | 6.4505 | 0.000672 |
| Example 2 | 98.5:1.5 | 678.3 | 8.8669 | 0.000308 |
| Example 3 | 98:2 | 681.5 | 9.0066 | 0.000469 |
| Example 4 | 92:8 | 621.5 | 8.9796 | 0.000395 |

TABLE 2
The compositions and property test results of
the ceramic materials at various weight ratios of magnesium
oxide powder to Eu₂O₃ powder.

| | Weight | | | |
|---|---|---|---|---|
| | ratio of | | | |
| | magnesium | | | |
| | oxide powder | | | |
| | to Eu₂O₃ | Hardness | Dk | Df |
| | powder | (Hv10) | (1 GHz) | (1 GHz) |
| Comparative | 100:0 | 368.1 | 7.4929 | 0.000526 |
| Example 1 | | | | |
| Example 5 | 98.5:1.5 | 711.6 | 10.053 | 0.000230 |
| Example 6 | 92:8 | 678.1 | 10.647 | 0.000136 |

TABLE 3
The compositions and property test results of
the ceramic materials at various weight ratios of magnesium
oxide powder to MnO₂ powder.

| | Weight | | | |
|---|---|---|---|---|
| | ratio of | | | |
| | magnesium | | | |
| | oxide powder | | | |
| | to MnO₂ | Hardness | Dk | Df |
| | powder | (Hv10) | (1 GHz) | (1 GHz) |
| Comparative | 100:0 | 368.1 | 7.4929 | 0.000526 |
| Example 1 | | | | |
| Example 7 | 99.5:0.5 | 544 | 9.4612 | 0.000251 |
| Example 8 | 95.5:4.5 | 581 | 9.8256 | 0.000307 |

TABLE 4
The compositions and property test results of
the ceramic materials at various weight ratios of magnesium
oxide powder to La₂O₃ powder.

| | Weight ratio of | |
|---|---|---|
| | magnesium | |
| | oxide powder | |
| | to La₂O₃ | Hardness |
| | powder | (Hv10) |
| Comparative | 100:0 | 368.1 |
| Example 1 | | |
| Comparative | 99:1 | 332 |
| Example 2 | | |
| Comparative | 98.5:1.5 | 256 |
| Example 3 | | |
| Comparative | 98:2 | 370 |
| Example 4 | | |
| Comparative | 96:4 | 419 |
| Example 5 | | |

TABLE 5
The compositions and property test results of
the ceramic materials at various weight ratios of magnesium
oxide powder to MoO₂ powder.

| | Weight ratio of | |
|---|---|---|
| | magnesium | |
| | oxide powder | |
| | to MoO₂ | Hardness |
| | powder | (Hv10) |
| Comparative | 100:0 | 368.1 |
| Example 1 | | |
| Comparative | 99:1 | 202 |
| Example 6 | | |
| Comparative | 98.5:1.5 | 157 |
| Example 7 | | |
| Comparative | 98:2 | 126 |
| Example 8 | | |
| Comparative | 96:4 | 148 |
| Example 9 | | |

TABLE 6
The compositions and property test results of the ceramic materials
at various weight ratios of magnesium oxide powder to NiO powder.

| | Weight ratio of | |
|---|---|---|
| | magnesium | |
| | oxide powder | Hardness |
| | to NiO powder | (Hv10) |
| Comparative | 100:0 | 368.1 |
| Example 1 | | |
| Comparative | 99:1 | 227.6 |
| Example 10 | | |
| Comparative | 98.5:1.5 | 209.2 |
| Example 11 | | |
| Comparative | 98:2 | 413.3 |
| Example 12 | | |
| Comparative | 96:4 | 426.9 |
| Example 13 | | |
| Comparative | 92:8 | 386.6 |
| Example 14 | | |

TABLE 7
The compositions and property test results of the ceramic materials
at various weight ratios of magnesium oxide powder to ZnO powder.

| | Weight ratio of | |
|---|---|---|
| | magnesium | |
| | oxide powder | Hardness |
| | to ZnO powder | (Hv10) |
| Comparative | 100:0 | 368.1 |
| Example 1 | | |
| Comparative | 99:1 | 382.4 |
| Example 15 | | |
| Comparative | 98.5:1.5 | 267.7 |
| Example 16 | | |
| Comparative | 98:2 | 305.3 |
| Example 17 | | |
| Comparative | 96:4 | 248.9 |
| Example 18 | | |
| Comparative | 92:8 | 267.7 |
| Example 19 | | |

Referring to Table 1 to Table 7 and FIG. 1, the experimental results show the ceramic materials of the disclosure (Examples 1 to 8), which are doped with either Co₃O₄, Eu₂O, or MnO₂, and with a weight ratio of magnesium oxide powder to Co₃O₄ powder, Eu₂O powder, or MnO₂ powder ranging from 99.9:0.1 to 92:8, exhibit a hardness of 450 Hv10 to 750 Hv10. In addition, compared to the magnesium oxide powder without any doping (Comparative Example 1), these doped ceramic materials exhibit higher hardness, which enhances their ability to maintain structural stability and resist thermal damage at high temperatures. In contrast, the ceramic materials doped with one of La₂O₃, MoO₂, NiO and ZnO (Comparative Example 2 to Comparative Example 19) have lower hardness. The reduction in hardness may affect the stability of the ceramic materials at high temperatures, leading to thermal expansion, deformation, or cracking under such conditions.

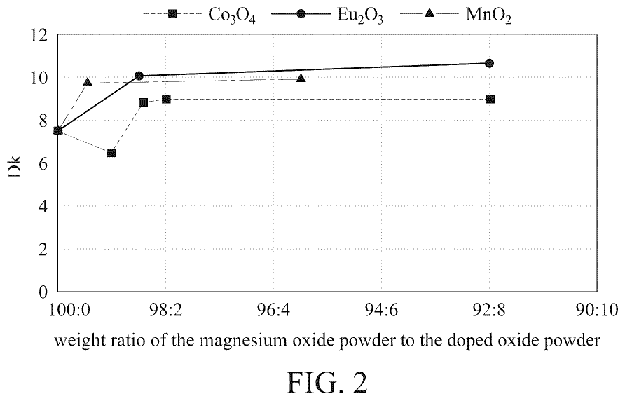

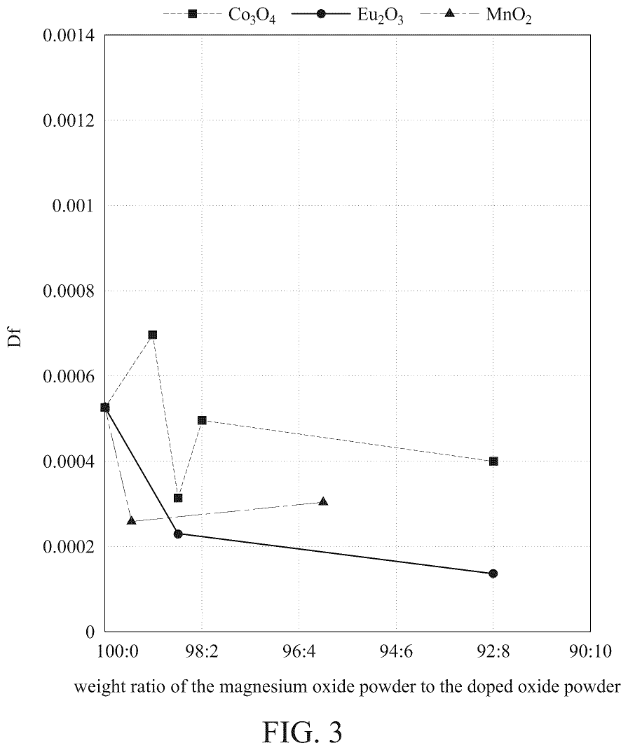

Furthermore, referring to Table 1 to Table 3 and FIG. 2 and FIG. 3, the experimental results show that the ceramic material of the disclosure (Example 1), which is doped with Co₃O₄ and has a weight ratio of magnesium oxide powder to Co₃O₄ powder of 99:1, exhibits a lower dielectric constant (Dk) compared to magnesium oxide powder without any doping (Comparative Example 1). In addition, it can be observed from the experimental results that the ceramic materials of the disclosure, doped with either Co₃O₄ powder, Eu₂O powder or MnO₂ powder, and with a weight ratio of magnesium oxide powder to Co₃O₄ powder, Eu₂O powder or MnO₂ powder of 99.9:0.1 to 92:8, exhibits a dissipation factor (Df) of less than 0.0007 (1 GHz), which is advantageous for the transmission of microwaves to carbon fibers through the ceramic materials during the carbon fiber graphitization process, enabling a more uniform and efficient heating process, thereby improving the quality of the carbon fibers. In addition, the ceramic materials of Examples 2 to 8 show a dissipation factor (Df) less than 0.0006 (1 GHz), further promoting the efficient microwave transmission during the graphitization process, resulting in better quality carbon fibers. While the dielectric constants (Dk) of some examples are slightly greater than that of Comparative Example 1, microwave transmission is primarily assessed based on the dissipation factor (Df) from a theoretical standpoint. Even when the impact of dielectric constant on microwave transmission is considered, the reduction of energy loss due to the low dissipation factor of the ceramic material of the disclosure significantly outweighs any potential increase in energy loss from the higher dielectric constant. Consequently, the ceramic material of the disclosure still exhibits superior microwave transmission capability. This property makes the ceramic material suitable for use in ceramic tubes for the high-temperature graphitization of carbon fibers, addressing issues such as low microwave energy transmission efficiency, mechanical property degradation, and redox reactions in ceramic tubes.

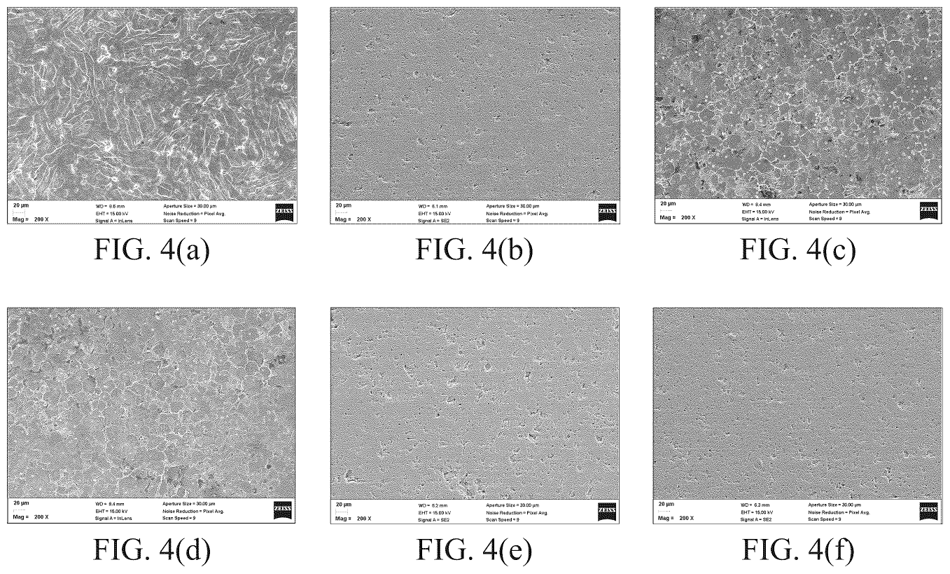

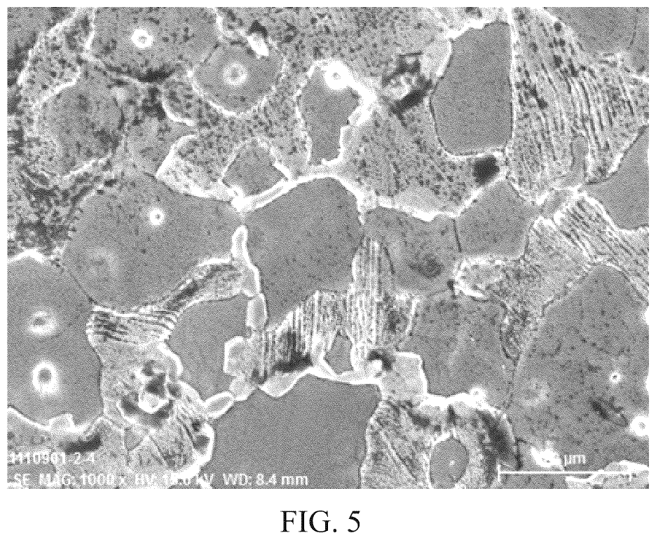

FIG. 4 shows the SEM images of ceramic materials composed of magnesium oxide powder and the doped oxide powder (Co₃O₄) at various weight ratio, where FIG. 4(a) to FIG. 4(f) are SEM images of the ceramic material made from the magnesium oxide powder and Co₃O₄ powder with a weight ratio of 100:0, 99:1, 98.5:1.5, 98:2, 96:4 and 92:8, respectively. FIG. 5 shows the high-magnification SEM image of the ceramic material (Example 3) made from the magnesium oxide powder and Co₃O₄ powder with a weight ratio of 98:2.

Referring to Table 1, FIG. 4 and FIG. 5, the experimental results and the SEM images reveal that when a small amount of Co₃O₄ powder is doped into the magnesium oxide powder, it helps prevent cracking in the magnesium oxide. In addition, as the amount of dopant increases, precipitates become clearly visible at the grain boundaries of magnesium oxide when the weight ratio of magnesium oxide powder to Co₃O₄ powder is 98.5:1.5 to 98:2. These precipitates exhibit an adhesive-like effect, which significantly enhances the hardness.

Table 8 to Table 10 show the composition of the ceramic materials of Examples 1, 3 and 4 of the disclosure measured by EDS elemental analysis.

TABLE 8
The composition of the ceramic material
of Example 1 of the disclosure.

| | | wt % |
|---|---|---|
| Example 1 | MgO | 96.0419 |
| | Al₂O₃ | 0.2877 |
| | SiO₂ | 0.7502 |
| | CaO | 1.0756 |
| | Fe₂O₃ | 0.1522 |
| | Co₃O₄ | 1.5002 |

TABLE 9
The composition of the ceramic material
of Example 3 of the disclosure.

| | | wt % |
|---|---|---|
| Example 3 | MgO | 94.5711 |
| | Al₂O₃ | 0.2255 |
| | SiO₂ | 0.9098 |
| | CaO | 1.0248 |
| | Fe₂O₃ | 0.1595 |
| | Co₃O₄ | 2.9083 |

TABLE 10
The composition of the ceramic material
of Example 4 of the disclosure.

| | | wt % |
|---|---|---|
| Example 4 | MgO | 86.4781 |
| | Al₂O₃ | 0.2689 |
| | SiO₂ | 0.7338 |
| | CaO | 0.9741 |
| | Fe₂O₃ | 0.1378 |
| | Co₃O₄ | 11.1385 |

It can be observed from Table 8 to Table 10 that each sample mainly includes MgO and Co₃O₄, with the proportion of Co₃O₄ being slightly higher than that of the doped raw material (Co₃O₄ powder). Additionally, components such as Al₂O₃, SiO₂, CaO and Fe₂O₃ may be present as impurities in the raw material.

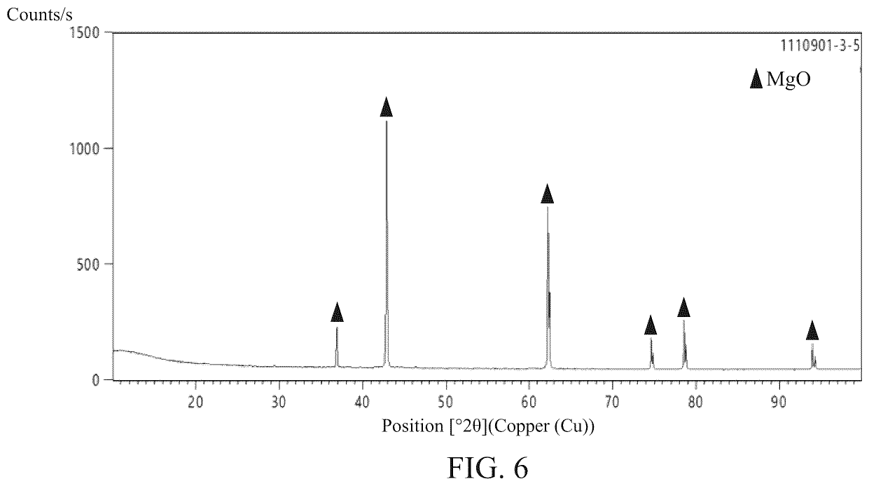

FIG. 6 shows the XRD pattern of the ceramic material made from the magnesium oxide powder and Co₃O₄ powder with a weight ratio of 98:2. As shown in the figure, the structure of the ceramic material (Example 3) predominantly consists of pure magnesium oxide.

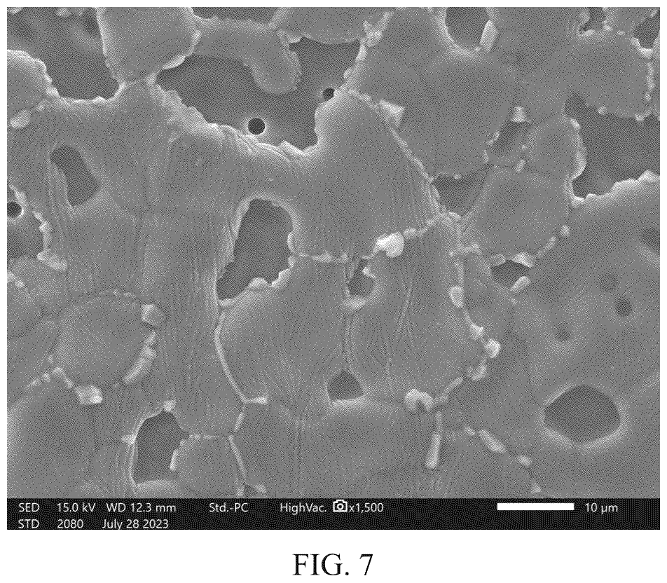

FIG. 7 shows the SEM image of the ceramic material (Comparative Example 17) made from the magnesium oxide powder and ZnO powder with a weight ratio of 98:2. As observed in the figure, the ceramic material does not exhibit any precipitate at the grain boundary of magnesium oxide, and therefore, which results in no increase in hardness.

Preparation of ceramic tube: the ceramic material of Example 2 is shaped into a ceramic tube by solid-state sintering.

High-temperature treatment: the ceramic tube is heated at 1400° C. or 2000° C.

Table 11 shows the structural parameters of the ceramic tube before and after high-temperature treatment.

TABLE 11
The structural parameters of the ceramic tube
before and after high-temperature treatment.

| | | After high- | After high- |
|---|---|---|---|
| | Before high- | temperature | temperature |
| | temperature | treatment at | treatment at |
| | treatment | 1400° C. | 2000° C. |
| Outer diameter | 33.38 | 33.02 | 32.533 |
| (mm) | | | |
| Inner diameter | 23.14 | 23.02 | 23.05 |
| (mm) | | | |
| Density (g/cm³) | 3.194 | 3.242 | 3.225 |
| Porosity (%) | 10.782 | 9.44 | 9.92 |

It can be observed from Table 11 that the ceramic tube made from the ceramic material of the disclosure exhibits minimal changes in structural parameters after high-temperature treatment at 1400° C. or 2000° C., proving that the ceramic material of the disclosure has high heat resistance, withstanding temperatures up to 2000° C.

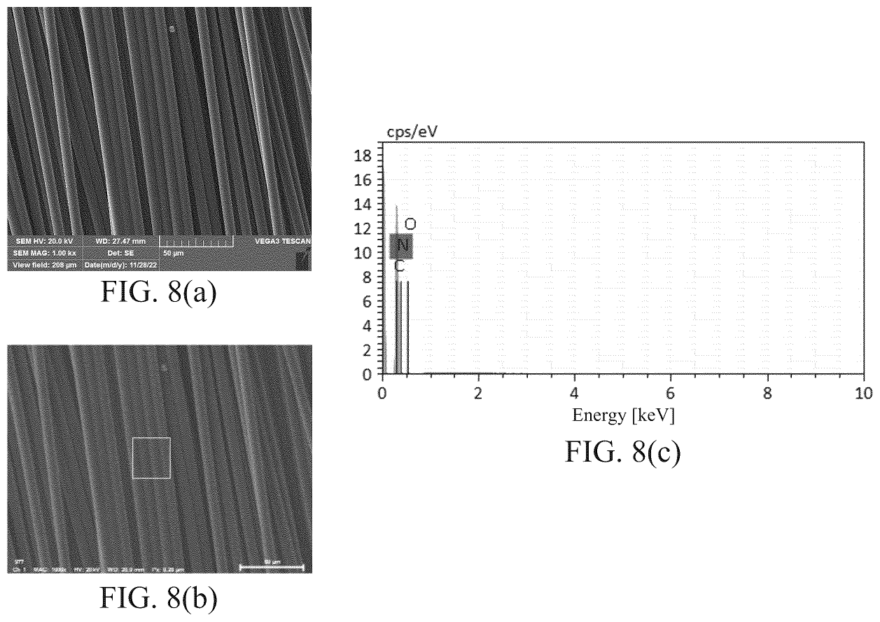

FIG. 8(a) to FIG. 8(c) show the SEM images and the EDS image of a graphitized fiber made by the ceramic material according to an embodiment of the disclosure, in which FIG. 8(a) and FIG. 8(b) are the SEM images of the graphitized fiber, while FIG. 8(c) is the EDS image of the square area of FIG. 8(b). It can be observed from FIG. 8(a) to FIG. 8(c) that the graphitized fiber made by the ceramic material of the disclosure does not contain contaminants (such as magnesium) and can have better purity and improves properties.

The ceramic material and manufacturing method thereof provided by the disclosure improve the sinterability of the ceramic material by doping specific types and proportions of oxides into magnesium oxide, while enhancing the hardness of the ceramic material and reducing the dissipation factor. It improves the hardness of the ceramic material and reduces the dissipation factor, resulting in superior mechanical and dielectric properties, without contaminating the heated object.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A ceramic material, comprising:
a magnesium oxide (MgO) and a doped oxide,
wherein the doped oxide comprises cobalt tetroxide (Co₃O₄), europium trioxide (Eu₂O₃) or manganese dioxide (MnO₂); and
wherein a weight ratio of the magnesium oxide to the doped oxide is 97:1 to 85:12.

2. The ceramic material as claimed in claim 1, wherein a Vickers hardness of the ceramic material is 450 Hv10 to 750 Hv10, and a dissipation factor (Df) of the ceramic material is 0.0001 (1 GHz) to 0.0007 (1 GHz).

3. The ceramic material as claimed in claim 1, wherein when the doped oxide is cobalt tetroxide, and a weight ratio of magnesium oxide to cobalt tetroxide is 86.4:11.13 to 96:1.5.

4. The ceramic material as claimed in claim 3, wherein a Vickers hardness of the ceramic material is 459.8 Hv10 to 700 Hv10, and a dissipation factor (Df) of the ceramic material is 0.0003 (1 GHz) to 0.0007 (1 GHz).

5. A method for manufacturing ceramic a material, comprising:
mixing a magnesium oxide powder and a doped oxide powder; and
sintering the mixed magnesium oxide powder and the doped oxide powder at a temperature of 1300° C. to 1650° C. to obtain the ceramic material as claimed in claim 1,
wherein the doped oxide powder comprises a cobalt tetroxide powder, a europium trioxide powder or a manganese dioxide powder; and
wherein a weight ratio of the magnesium oxide powder to the doped oxide powder is 99.9:0.1 to 92:8.

6. The method for manufacturing ceramic material as claimed in claim 5, wherein when the doped oxide powder is the cobalt tetroxide powder, and a weight ratio of the magnesium oxide powder to the cobalt tetroxide powder is 99:1 to 92:8.

7. The method for manufacturing ceramic material as claimed in claim 6, wherein a Vickers hardness of the ceramic material is 450 Hv10 to 749 Hv10, and a dissipation factor (Df) of the ceramic material is 0.00027 (1 GHz) to 0.0007 (1 GHz).

8. The method for manufacturing ceramic material as claimed in claim 5, wherein when the doped oxide powder is the europium trioxide powder, a weight ratio of the magnesium oxide powder to the europium trioxide powder is 98.5:1.5 to 92:8.

9. The method for manufacturing ceramic material as claimed in claim 8, wherein a Vickers hardness of the ceramic material is 610 Hv10 to 750 Hv10, and a dissipation factor (Df) of the ceramic material is 0.00012 (1 GHz) to 0.00025 (1 GHz).

10. The method for manufacturing ceramic material as claimed in claim 5, wherein when the doped oxide powder is the manganese dioxide powder, a weight ratio of the magnesium oxide powder and the manganese dioxide powder is 99.5:0.5 to 95.5:4.5.

11. The method for manufacturing ceramic material as claimed in 10, wherein a Vickers hardness of the ceramic material is 489 Hv10 to 639 Hv10, and a dissipation factor (Df) of the ceramic material is 0.00022 (1 GHz) to 0.00034 (1 GHz).
